(19) United States
(12) Patent Application Publication
(10) Pub. No.: US 2026/0091624 A1
(43) Pub. Date: Apr. 2, 2026

(54) ENERGY-SAVING POSITIONING METHOD FOR TIRE PRESSURE DETECTORS

(71) Applicants: WILLIAM DAVID STEWART, TAIPEI CITY (TW); CHIH-WEI YU, TAIPEI CITY (TW)

(72) Inventors: WILLIAM DAVID STEWART, TAIPEI CITY (TW); CHIH-WEI YU, TAIPEI CITY (TW)

(21) Appl. No.: 19/295,720

(22) Filed: Aug. 11, 2025

(30) Foreign Application Priority Data
Sep. 27, 2024 (TW) 113137014

(51) Int. Cl. B60C 23/04

(52) U.S. Cl. CPC B60C 23/0464; B60C 23/0474

(57) ABSTRACT

An energy-saving positioning method for tire pressure detectors includes the following steps: the vehicle main unit determines whether the engine switch changes from on to off; each tire pressure detector records initial data of at least two axes (X, Y, Z); each detector periodically records subsequent axial data; the vehicle main unit sends an engine start signal to all detectors; each detector compares recorded values with the last recorded values to check for changes; the vehicle main unit evaluates position change messages from detectors and proceeds accordingly. If changes occurred, then go to Step 5A: the main unit skips automatic positioning and uses previous positioning data. If no changes occurred, then go to Step 5B: the main unit initiates automatic positioning. This method effectively reduces positioning frequency compared to traditional systems that require repositioning every engine restart, thereby achieving power conservation while maintaining system accuracy and reliability.

### BACKGROUND OF THE INVENTION

### 1. Fields of the Invention

The present invention relates to an energy-saving positioning method for tire pressure detectors that can effectively reduce the number of automatic positioning operations to conserve power consumption.

### 2. Descriptions of Related Art

Generally speaking, a complete tire pressure monitoring system requires at least one tire pressure detector installed on each wheel, and the main system of the vehicle needs to be equipped with a device for monitoring data. Since the wheels rotate at high speed during vehicle operation, wired transmission between the tire pressure detectors and the data monitoring device is not suitable. Conventional vehicles are typically equipped with at least four wheels. In wireless connection scenarios, the main unit determines which wheel that each tire pressure detector belongs to by using the X-axis, Y-axis, and Z-axis data from individual tire pressure detectors. However, this identification method currently has some issues that need improvement. For example, every time the vehicle starts, the main unit of the vehicle needs to perform repositioning for all tire pressure detectors, and positioning errors frequently occur, requiring continuous repeated positioning operations. This is both power-consuming and time-consuming.

The present invention intends to provide an energy-saving positioning method for tire pressure detectors to eliminate the shortcomings mentioned above.

### SUMMARY OF THE INVENTION

The present invention relates to an energy-saving positioning method for tire pressure detectors, which comprises the following steps:
Step 1: A vehicle main unit determines whether an engine switch has changed from on to off, if yes, proceed to the next step;
Step 2: Each tire pressure detector respectively records initial data of at least two of an X-axis, a Y-axis, and a Z-axis, wherein the initial recorded data is designated as values X0, Y0, Z0, after the initial data recording is completed, proceed to the next step;
Step 3: Each tire pressure detector respectively records data of at least two of the X-axis, the Y-axis, and the Z-axis periodically, wherein the data recorded at this stage is designated as values X, Y, Z, the vehicle main unit simultaneously determines whether the engine switch has changed from off to on, if yes, proceed to the next step; Step 4: The vehicle main unit sends an engine switch-on signal to each tire pressure detector, after transmission is completed, proceed to the next step;
Step 5: Each tire pressure detector checks whether there are changes between the recorded values X0, Y0, Z0 and the last recorded values X, Y, Z, then sends a position change message to the vehicle main unit, after the position change message transmission is completed, proceed to step 6;
Step 6: The vehicle main unit makes a determination based on the position change messages received from the tire pressure detectors, if there is no change, proceed to step 7A, if there is change, proceed to step 7B;
Step 7A: The vehicle main unit does not perform automatic positioning, the vehicle main unit continues to use the previous positioning data of each tire pressure detector, and
Step 7B: The vehicle main unit initiates automatic positioning.

The present invention also provide another energy-saving positioning method for tire pressure detectors, which comprises the following steps:
Step 1: A vehicle main unit determines whether an engine switch has changed from on to off, if yes, proceed to the next step;
Step 2: Each tire pressure detector respectively records initial data of at least two of an X-axis, a Y-axis, and a Z-axis, wherein the initial recorded data is designated as values X0, Y0, Z0, after the initial data recording is completed, proceed to the next step;
Step 3: Each tire pressure detector respectively records data of at least two of the X-axis, the Y-axis, and the Z-axis periodically, wherein the data recorded at this stage is designated as values X, Y, Z, and each recording is compared with values X0, Y0, Z0, the vehicle main unit simultaneously determines whether the engine switch has changed from off to on, if yes, proceed to the next step;
Step 4: The vehicle main unit connects with each tire pressure detector, and each tire pressure detector reports whether changes have ever occurred during a standby period in the data comparison between values X, Y, Z and values X0, Y0, Z0, then sends a position change message to the vehicle main unit, after the position change message transmission is completed, proceed to step 5;
Step 5: The vehicle main unit makes a determination based on the position change messages received from the tire pressure detectors, if there is no change, proceed to step 5A, if there is change, proceed to step 5B;
Step 5A: The vehicle main unit does not perform automatic positioning; the vehicle main unit continues to use the previous positioning data of each tire pressure detector, and
Step 5B: The vehicle main unit initiates automatic positioning.

The primary object of the present invention is to provide an energy-saving positioning method for tire pressure detectors, after engine shutdown, each tire pressure detector records an initial set of position data regarding the X-axis, the Y-axis, and the Z-axis. Additionally, each tire pressure detector periodically records data about the X-axis, the Y-axis, and the Z-axis. When the vehicle engine starts, each tire pressure detector compares the initial data with the last recorded data regarding the X-axis, the Y-axis, and the Z-axis. If they match, the detector reports a “no position change” message to the vehicle's main unit. When the vehicle's main unit receives “no position change” messages from all tire pressure detectors, it will continue to use the previous positioning data of each tire pressure detector and will not perform automatic positioning. Compared to traditional methods where repositioning is required every time the vehicle engine restarts, the method provided by the present invention can effectively reduce the number of positioning operations, thereby achieving the purpose of power conservation.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a flowchart diagram of the method of the present invention;

FIG. 2 is a system configuration diagram applying the method of the present invention;

FIG. 3 is a flowchart diagram of the second method of the present invention, and

FIG. 4 is a flowchart diagram of the third method of the present invention.

### DETAILED DESCRIPTION OF THE PREFERRED EMBODIMENT

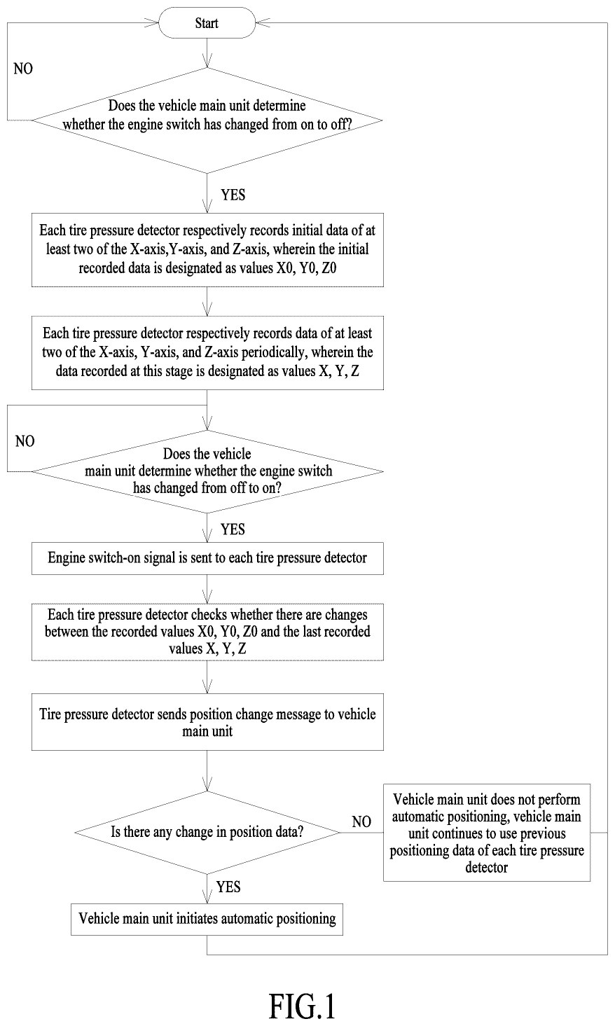

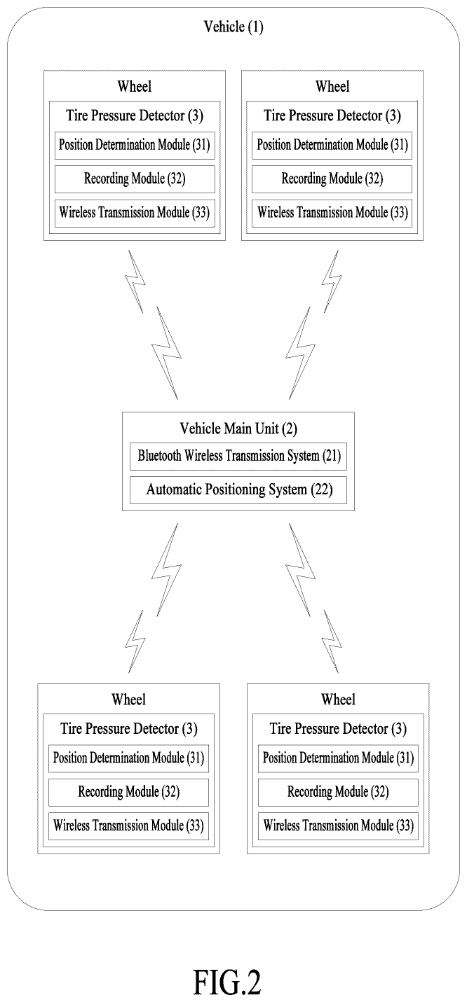

Referring to FIGS. 1 and 2, an energy-saving positioning method for tire pressure detectors the of the present invention comprises the following steps: Step 1: The vehicle main unit 2 determines whether the engine switch has changed from on to off; if yes, proceed to the next step;
Step 2: Each tire pressure detector 3 respectively records initial data of at least two of the X-axis, the Y-axis, and the Z-axis, wherein the initial recorded data is designated as values X0, Y0, Z0; after the initial data recording is completed, proceed to the next step;
Step 3: Each tire pressure detector 3 respectively records data of at least two of the X-axis, the Y-axis, and the Z-axis periodically, wherein the data recorded at this stage is designated as values X, Y, Z; additionally, the vehicle main unit 2 simultaneously determines whether the engine switch has changed from off to on; if yes, proceed to the next step;
Step 4: The vehicle main unit 2 sends an engine switch-on signal to each tire pressure detector 3; after transmission is completed, proceed to the next step;
Step 5: Each tire pressure detector 3 checks whether there are changes between the recorded values X0, Y0, Z0 and the last recorded values X, Y, Z, then sends a position change message to the vehicle main unit 2; after the position change message transmission is completed, proceed to step 6;
Step 6: The vehicle main unit 2 makes a determination based on the position change messages received from the tire pressure detectors 3; if there is no change, proceed to step 7A; if there is change, proceed to step 7B;
Step 7A: The vehicle main unit 2 does not perform automatic positioning; the vehicle main unit 2 continues to use the previous positioning data of each tire pressure detector 3, and
Step 7B: The vehicle main unit 2 initiates automatic positioning.

In this embodiment, the vehicle main unit 2 receives power from the vehicle 1 and matches with the wireless transmission modules 33 of the tire pressure detectors 3 on each wheel through a Bluetooth wireless transmission system 21. The vehicle main unit 2 includes an automatic positioning system 22, while each tire pressure detector 3 includes a position determination module 31 (such as an accelerometer) for determining its own position, and includes a recording module 32 capable of recording X, Y, Z-axis data for its respective position. The key point of the method provided by the present invention is that after engine shutdown, each tire pressure detector 3 records an initial set of position data regarding the X-axis, the Y-axis, and the Z-axis (values X0, Y0, Z0). Additionally, each tire pressure detector 3 periodically records data about the X-axis, the Y-axis, and the Z-axis. When the vehicle 1 engine starts, each tire pressure detector 3 compares the initial data (values X0, Y0, Z0) with the last recorded data regarding the X-axis, the Y-axis, and the Z-axis, and reports position change messages to the vehicle main unit 2. The value comparison can be for a single axis or any combination of axes, for example, comparing only the X-axis, or only the Y-axis and the Z-axis. When the vehicle main unit 2 receives position change messages from all tire pressure detectors 3, if there is no change, it will continue to use the previous positioning data of each tire pressure detector 3 and will not perform automatic positioning. Compared to traditional methods where repositioning is required every time the vehicle engine restarts, the method provided by the present invention can effectively reduce the number of positioning operations, thereby achieving the purpose of power conservation.

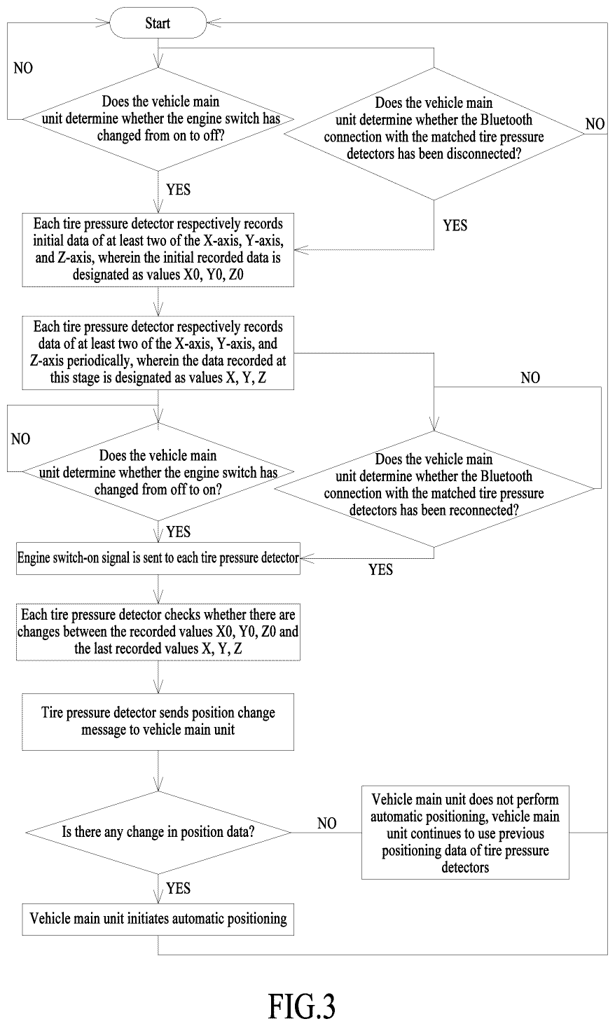

As shown in FIG. 3, the judgment condition for proceeding to the next step in Step 1 can be that the vehicle main unit 2 determines whether the engine switch has changed from on to off or whether the Bluetooth connection with the matched tire pressure detectors 3 has been disconnected. If either of the aforementioned two conditions is true, then proceed to the next step. The judgment condition for proceeding to the next step in Step 3 can be that the vehicle main unit 2 determines whether the engine switch has changed from off to on or whether the Bluetooth connection with the matched tire pressure detectors 3 has been reconnected. If either of the aforementioned two conditions is true, then proceed to the next step. This embodiment can avoid situations where the vehicle main unit system for recognizing the engine switch status malfunctions, ensuring that the method of the present invention can still continue to operate.

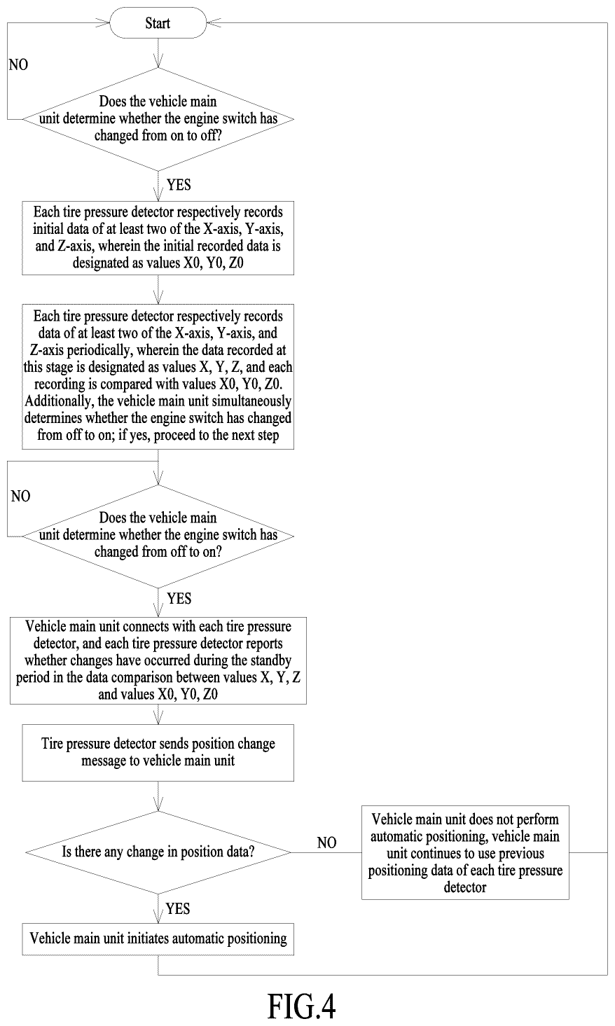

As shown in FIG. 4, the present invention has another process in addition to the aforementioned flow. The main difference is that in the flow of FIG. 4, during the standby process of each tire pressure detector 3, every time the values X, Y, Z are recorded, they are compared once with the values X0, Y0, Z0.

While we have shown and described the embodiment in accordance with the present invention, it should be clear to those skilled in the art that further embodiments may be made without departing from the scope of the present invention.

What is claimed is:

1. An energy-saving positioning method for tire pressure detectors, comprising the following steps:
Step 1: A vehicle main unit determines whether an engine switch has changed from on to off, if yes, proceed to the next step;
Step 2: Each tire pressure detector respectively records initial data of at least two of an X-axis, a Y-axis, and a Z-axis, wherein the initial recorded data is designated as values X0, Y0, Z0, after the initial data recording is completed, proceed to the next step;
Step 3: Each tire pressure detector respectively records data of at least two of the X-axis, the Y-axis, and the Z-axis periodically, wherein the data recorded at this stage is designated as values X, Y, Z, the vehicle main unit simultaneously determines whether the engine switch has changed from off to on, if yes, proceed to the next step;
Step 4: The vehicle main unit sends an engine switch-on signal to each tire pressure detector, after transmission is completed, proceed to the next step;
Step 5: Each tire pressure detector checks whether there are changes between the recorded values X0, Y0, Z0 and the last recorded values X, Y, Z, then sends a position change message to the vehicle main unit, after the position change message transmission is completed, proceed to step 6;
Step 6: The vehicle main unit makes a determination based on the position change messages received from the tire pressure detectors, if there is no change, proceed to step 7A, if there is change, proceed to step 7B;
Step 7A: The vehicle main unit does not perform automatic positioning, the vehicle main unit continues to use the previous positioning data of each tire pressure detector, and
Step 7B: The vehicle main unit initiates automatic positioning.

2. The method as claimed in claim 1, wherein a judgment condition for proceeding to the next step in Step 1 is that the vehicle main unit determines whether the engine switch has changed from on to off or whether a Bluetooth connection with the matched tire pressure detectors has been disconnected, if either of the aforementioned two conditions is true, then proceed to the next step.

3. The method as claimed in claim 1, wherein a judgment condition for proceeding to the next step in Step 3 is that the vehicle main unit determines whether the engine switch has changed from off to on or whether a Bluetooth connection with the matched tire pressure detectors has been reconnected, if either of the aforementioned two conditions is true, then proceed to the next step.

4. An energy-saving positioning method for tire pressure detectors, comprising the following steps:
Step 1: A vehicle main unit determines whether an engine switch has changed from on to off, if yes, proceed to the next step;
Step 2: Each tire pressure detector respectively records initial data of at least two of an X-axis, a Y-axis, and a Z-axis, wherein the initial recorded data is designated as values X0, Y0, Z0, after the initial data recording is completed, proceed to the next step;
Step 3: Each tire pressure detector respectively records data of at least two of the X-axis, the Y-axis, and the Z-axis periodically, wherein the data recorded at this stage is designated as values X, Y, Z, and each recording is compared with values X0, Y0, Z0, the vehicle main unit simultaneously determines whether the engine switch has changed from off to on, if yes, proceed to the next step;
Step 4: The vehicle main unit connects with each tire pressure detector, and each tire pressure detector reports whether changes have ever occurred during a standby period in the data comparison between values X, Y, Z and values X0, Y0, Z0, then sends a position change message to the vehicle main unit, after the position change message transmission is completed, proceed to step 5;
Step 5: The vehicle main unit makes a determination based on the position change messages received from the tire pressure detectors, if there is no change, proceed to step 5A, if there is change, proceed to step 5B;
Step 5A: The vehicle main unit does not perform automatic positioning; the vehicle main unit continues to use the previous positioning data of each tire pressure detector, and
Step 5B: The vehicle main unit initiates automatic positioning.

5. The method as claimed in claim 4, wherein a judgment condition for proceeding to the next step in Step 1 is that the vehicle main unit determines whether the engine switch has changed from on to off or whether a Bluetooth connection with the matched tire pressure detectors has been disconnected, if either of the aforementioned two conditions is true, then proceed to the next step.

6. The method as claimed in claim 4, wherein a judgment condition for proceeding to the next step in Step 3 is that the vehicle main unit determines whether the engine switch has changed from off to on or whether a Bluetooth connection with the matched tire pressure detectors has been reconnected, if either of the aforementioned two conditions is true, then proceed to the next step.
